(19) United States
(12) Patent Application Publication
(10) Pub. No.: US 2024/0043103 A1
(43) Pub. Date: Feb. 8, 2024

(54) SYSTEMS AND METHODS TO REVERSIBLY SPAN A SURFACE OF A WATERWAY

(71) Applicant: LUDLUM MEASUREMENTS, INC., Sweetwater, TX (US)

(72) Inventors: Erik V. Van Otten, Spanish Fork, UT (US); Wyatt M. Felt, Millcreek, UT (US); Jacob S. Yardley, West Jordan, UT (US); Jacob R. Greenwood, Orem, UT (US)

(21) Appl. No.: 18/491,610

(22) Filed: Oct. 20, 2023

Related U.S. Application Data
(63) Continuation-in-part of application No. 18/304,262, filed on Apr. 20, 2023.
(60) Provisional application No. 63/333,367, filed on Apr. 21, 2022.

(51) Int. Cl. B63B 35/32; B63B 21/50; B63B 22/04; B63B 79/40; E02B 15/06

(52) U.S. Cl. CPC B63B 35/32; B63B 21/50; B63B 22/04; B63B 79/40; E02B 15/06; B63B 2035/4466

(57) ABSTRACT

Disclosed systems, devices, and methods support an automated dynamic way to reversibly span the surface of a waterway, and may include deploying a floating boom and catch bin to redirect and capture floating waste before it reaches the terminus of the waterwaye; detecting, by a sensor suite, impending boat traffic; activating, by a control system, one or more actuating line motors for one or more closing lines; verifying, by the control system, a closed configuration; verifying, by the control system, whether a battery bank charge is above a required threshold, where if the battery bank charge falls below the required threshold then the system remains in the closed configuration; activating, by the control system, one or more actuating line motors for one or more opening lines if the battery bank charge is above the required threshold; and verifying, by the control system, an open configuration of the system.

### CROSS-REFERENCE TO RELATED APPLICATIONS

This application is a continuation-in-part of U.S. Non-Provisional application Ser. No. 18/304,262 filed Apr. 20, 2023, which claims the priority benefit of U.S. Provisional Application No. 63/333,367 filed Apr. 21, 2022, all of which are incorporated herein by reference in their entirety for all purposes.

### TECHNICAL FIELD

Embodiments relate generally to waste removal and more particularly to waste removal from waterways.

### BACKGROUND

Chemical and plastic waste have plagued oceans and waterways in a manner that is affecting numerous ecosystems. The number of pieces of plastic debris in the oceans are now at staggering 5 trillion, and of that amount more than 250,000 tons float on the surface. This environmental challenge is going to continue to get worse unless the process of waste collection becomes more effective.

### SUMMARY

The disclosed method and system support an automated dynamic way to reversibly span the surface of a waterway. The purpose of the span could be, for example, to deploy a floating boom and catch bin to redirect and capture floating litter/oil before it reaches the terminus of the waterway. The span could also be used to expose turbines to the hydrokinetic energy of the river. In its open or spanning configuration, the disclosed method can use a floating trash/debris boom to guide litter into catch bin, debris boom, or garbage trap.

A system embodiment may include a system, comprising: a moored buoy; a moored platform located downstream relative to a pivoting beam with respect to a direction of a waterway flow; an upstream floating boom having a first end and a second end, the upstream floating boom attached to the moored buoy at the first end; a downstream floating boom having a first end and a second end, the downstream floating boom attached to the moored platform at the first end; the pivoting beam located downstream of the moored buoy with respect to a direction of the waterway flow, wherein the upstream floating boom may be attached to an end of the pivoting beam at the second end of the floating boom, the pivoting beam pivotable between an open configuration and a closed configuration, wherein the pivoting beam comprises floats; a catch bin located at the end the pivoting beam and the second end of the downstream floating boom, wherein, in the open configuration of the pivoting beam, the floating boom may be configured to guide floating pollutants into the catch bin; wherein the catch bin is modified to act as a gate, which is located; at the end of the pivoting beam, wherein the gate prevents loss of trash during a tidal flow; and a shuttle located at a hinge of the pivoting beam, the shuttle may be a floating platform that comprises a battery bank, control system, power management system, and actuating motors/spools.

In some embodiments, an upstream line and a downstream line are coupled to a floating platform shuttle to activate open and closed configurations. The floating platform shuttle may comprise a motor that is capable of pulling both a downstream line and the upstream line to cause the pivoting beams to close and open, wherein the downstream line is coupled from the shuttle to the moored platform and the upstream line is coupled from the shuttle to the moored buoy, wherein the upstream line and downstream line can be a continuous line.

The moored buoy may be connected to a mooring pile and the moored buoy may configured to be connected to a vessel. The upstream floating boom includes a first floating boom and a second floating boom, the first floating boom and the second floating boom may be connected to the moored buoy at the first end of each of the first floating boom and the second floating boom, wherein the downstream floating boom includes a third floating boom and a fourth floating boom, the third floating boom and the fourth floating boom connected to the moored platform at the first end of each of the third floating boom and the fourth floating boom. The pivoting beam includes a first pivoting beam and a second pivoting beam, the first pivoting beam connected to the second pivoting beam at a center hinge, the first floating boom connected to the first pivoting beam and the second floating boom connected to the second pivoting beam.

In some embodiments, a closing line may be connected to a moored platform and the pivoting beam, and wherein, when the closing line may be retracted, the pivoting beam moves from the open configuration to the closed configuration. An opening line may be connected to the moored platform and the pivoting beam, and wherein, when the opening line may be retracted, the pivoting beam moves from the closed configuration to the open configuration.

Moreover, the system comprises markings on the pivoting beam and a power generation turbine located on the pivoting beam. A sensor suite may be located either in the shuttle or in the moored platform. The moored platform may be a mechanized trash collection conveyor or a simple moored buoy. The one or more downstream floating booms may be attached the moored platform to create a debris collection area. The pivoting beam comprises a structure of floats to provide sufficient strength to withstand static and dynamic forces.

A method embodiment may comprise detecting, by a sensor suite, impending boat traffic; activating an upstream line and a downstream line that are each coupled to a shuttle to move a pivoting beam from an open configuration to a closed configuration; an upstream floating boom connected to a moored buoy at a first end of the upstream floating boom and the pivoting beam at a second end of the upstream floating boom, a downstream floating boom connected to a moored platform at a first end of the downstream floating boom and the pivoting beam at a second end of the downstream floating boom, a catch bin connected to the pivoting beam such that, in the open configuration, the upstream floating boom directs floating pollutants toward a gate of the catch bin, wherein activation may be executed via a single pully or winch; verifying that the pivoting beam may be in the closed configuration; detecting a charge of a battery bank, wherein if the charge of the battery bank may be below a threshold, then the pivoting beam remains in the closed configuration; and if the charge of the battery bank may be above the threshold, activating a motor for an upstream and a downstream line; and verifying that the pivoting beam may be in the open configuration.

The sensor suite, the battery bank, and the motor may be located on a shuttle located at a hinge of the pivoting beam. Moreover, the sensor suite includes one or more of a Marine RADAR system, mm-Wave radar, digital compass, visual camera, near-infrared camera, LIDAR, proximity sensors, optical tripwires, GPS location system, VHF radio, or an Automatic Identification System (AIS) transceiver. The method further comprises charging the battery bank with a power generator, wherein the power generator includes a turbine located on the pivoting beam, and activating the motor if the sensor suite detects no impending boat traffic.

A non-transient computer readable medium embodiment containing program instructions for causing a computer to perform the method of: detecting, by a sensor suite, an impending boat traffic in a waterway; measuring, by the sensor suite, one or more weather conditions; measuring, by the sensor suite, a flow rate of a waterway, wherein the suite sensor is located in a floating platform shuttle; determining a desired width of an open configuration of a pivoting beam based on at least one of: the detected impending boat traffic, the measured one or more weather conditions, or the measured flow rate of the waterway; detecting a charge of a battery bank, wherein if the charge of the battery bank may be below a threshold, then the pivoting beam remains in a closed configuration; and activating an opening actuator for the pivoting beam if the battery bank may be above the threshold and the desired width may be greater than a current width of the pivoting beam, wherein the sensor suite, and the battery bank may be located in a floating platform shuttle, wherein the floating platform shuttle activates opening and closing of the pivoting beam by pulling an upstream line and a downstream line, wherein the upstream line is coupled between a moored buoy and the pivoting beam and the downstream line is coupled between a moored platform and the pivoting beam.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a first system with multiple floating booms in an open configuration for guiding floating pollutants into respective catch bins, according to one embodiment;

FIG. 1B depicts a second system with multiple floating booms in an open configuration for guiding floating pollutants into respective catch bins, according to one embodiment;

FIG. 1C depicts another embodiment of the second system with multiple floating booms in a partially closed configuration;

FIG. 2A depicts the second system of FIG. 1A in a closed configuration where width is reduced to allow boat traffic to traverse the waterway unimpeded, according to one embodiment;

FIG. 2B depicts the second system of FIG. 1B in a closed configuration where width is reduced to allow boat traffic to traverse the waterway unimpeded, according to one embodiment;

FIG. 3A depicts a close-up view of the moored platform in the first system of FIG. 1A, according to one embodiment;

FIG. 3B depicts a close-up view of the moored platform in the second system of FIG. 1B, according to one embodiment;

FIG. 4A depicts an alternate system in an open configuration for guiding floating pollutants into a catch bin, according to one embodiment;

FIG. 4B depicts the alternate system of FIG. 4A in a closed configuration, according to one embodiment;

FIGS. 5A-5D depict alternate system embodiments for use in environments where the water flow direction relative to a system is not expected to reverse direction during use;

FIG. 6 depicts a high-level flowchart of a method for deploying a system to reversibly span a surface of a waterway, according to one embodiment;

FIG. 7 depicts a high-level block diagram of the moored platform of FIG. 3A, according to one embodiment;

FIG. 8 depicts a high-level flowchart of a method for determining a desired width of a system that spans at least a portion of a surface of a waterway, according to one embodiment;

FIG. 9 shows a high-level block diagram and process of a computing system for implementing an embodiment of the system and process;

FIG. 10 shows a block diagram and process of an exemplary system in which an embodiment may be implemented; and

FIG. 11 depicts a cloud computing environment for implementing an embodiment of the system and process disclosed herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

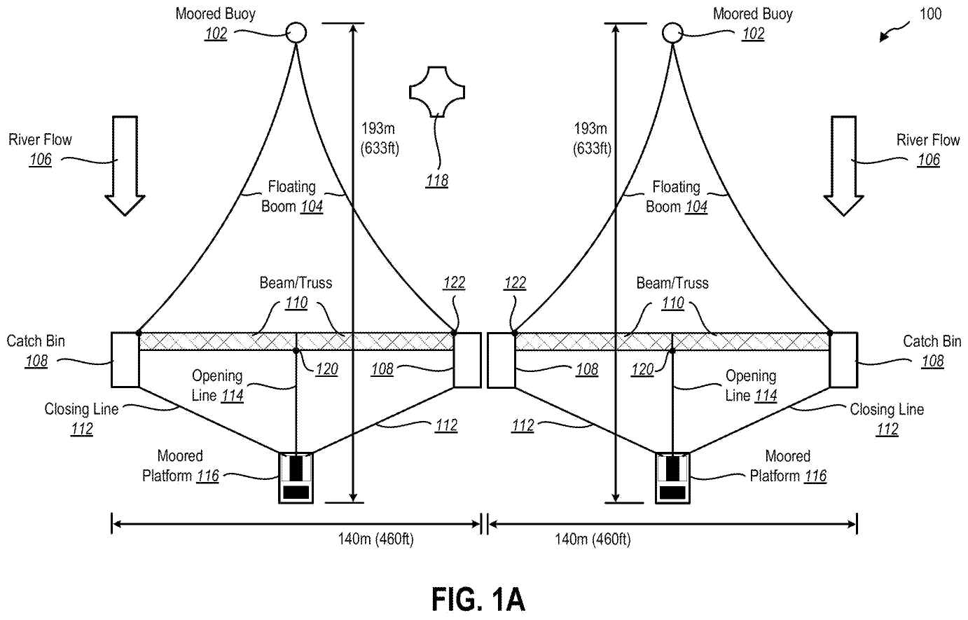

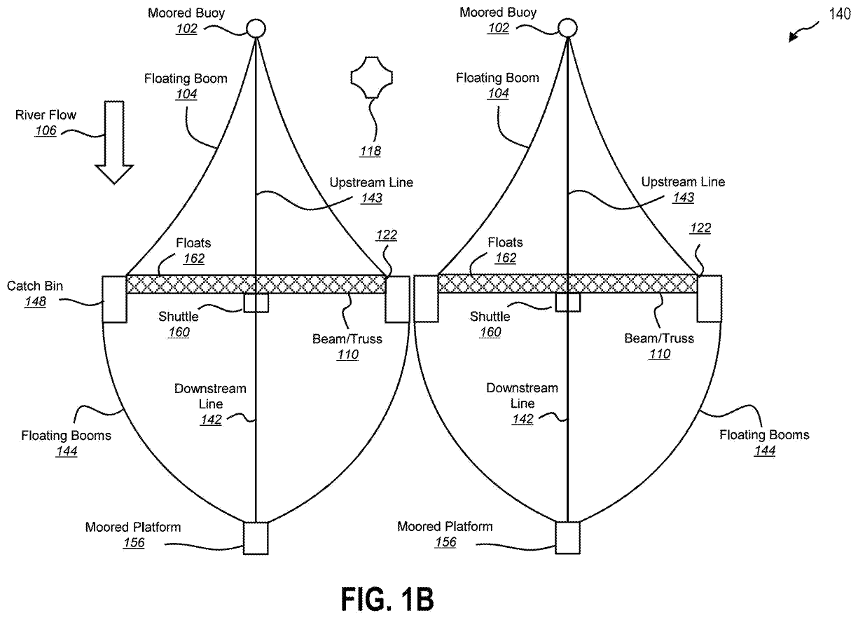

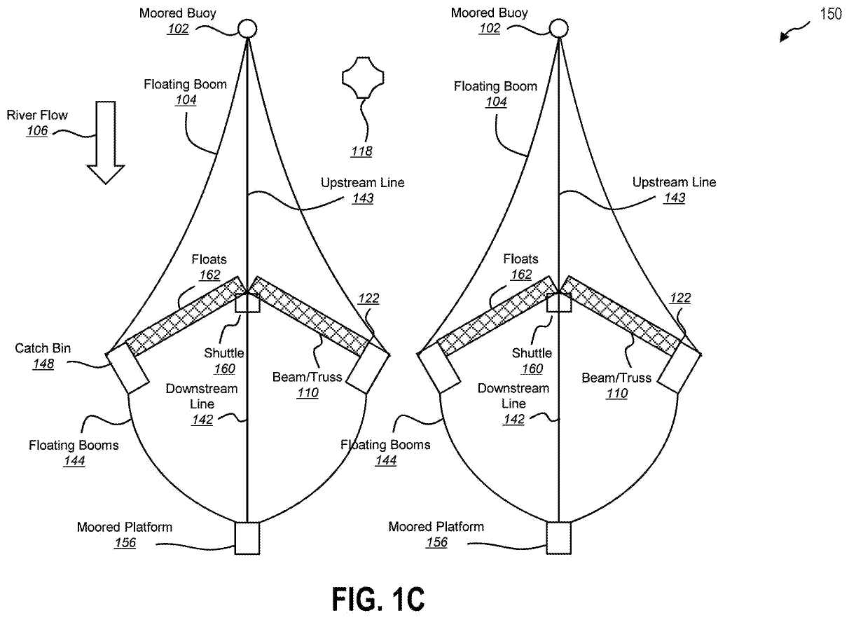

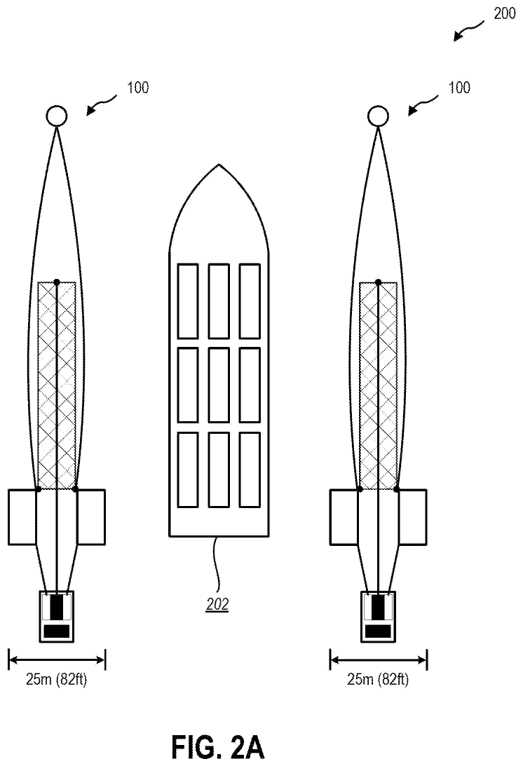

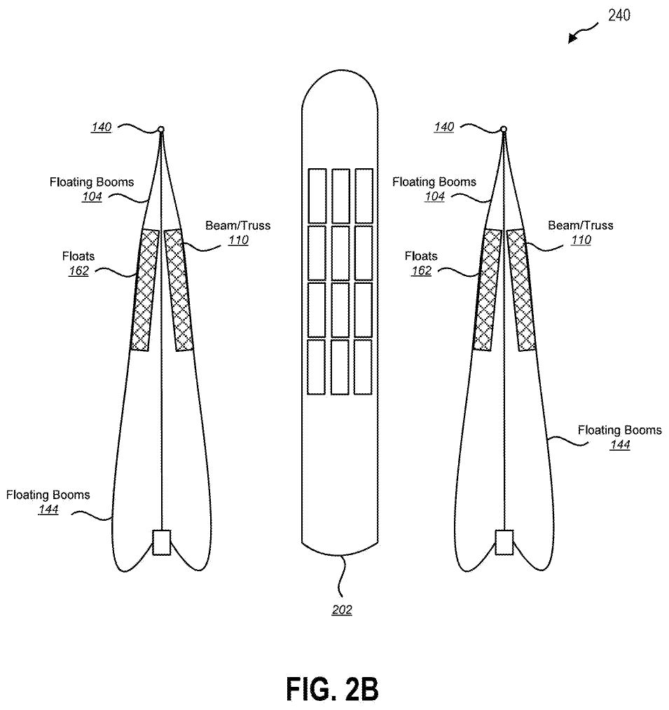

The disclosed method and system support an automated dynamic way to reversibly span the surface of a waterway. The purpose of the span could be, for example, to deploy a floating boom and catch bin to redirect and capture floating litter/oil before it reaches the terminus of the waterway. The span could also be used to expose turbines to the hydrokinetic energy of the river. In its open or spanning configuration, the disclosed method can use a floating trash/debris boom to guide litter into a catch bin, debris boom, or garbage trap (FIGS. 1A/1B/1C). Hydrokinetic turbine(s) (or current energy converter(s)) can also be connected to the system to capture energy from the river. The spanning of the system could expose these turbines to a greater cross-sectional area of the river, with correspondingly greater convertible energy. When the system detects impending ships and small boats, a collapsing sequence will be triggered that allows the assembly to fold into itself and clear the path for the river traffic (FIG. 2A/2B). When the traffic has passed, the system can redeploy and resume operations. This actuation is accomplished with cables or chains powered by electric motors located on a moored platform (first system) or a shuttle located at the hinge of the truss (second system).

The system may be powered by a hydrokinetic turbine, solar energy, or shore-based power. A sensor suite used to detect the impeding shore traffic may be located on the shore of the waterway and/or may be part of the moored system. The system could use other methods to govern the opening and closing of the span, including time-based systems and operator-based control. The dimensions of the system can vary from those shown herein. The large dimensions depicted herein illustrate how the system could be large enough to allow 50-meter-wide vessels to pass between two instances of the system. The system can be designed to be symmetric. This configuration may be useful for mid-river deployments.

The techniques described herein may provide one or more benefits and/or advantages over conventional systems. For example, the techniques described herein may be utilized in large waterways with substantial floating debris and vessel traffic. The techniques may be operated in waterways where the flow periodically reverses. This reversal may come, for example, from tidal flows. The techniques described herein may detects, track, and appropriately respond to proximal surface traffic in the waterway. The systems described herein may collects as much floating trash and other debris/pollutants in the highest levels of the water column as is reasonable without impeding surface traffic. The systems described herein may store the collected pollutants until they can be properly disposed of. The systems may be powered by harnessing the hydrokinetic energy of the river where it is deployed. The systems may covert additional hydrokinetic energy, beyond its own needs, for other uses and/or external transmission. The systems may be made of materials that can withstand a riverine/marine environment for extended periods of time. The systems may be clearly marked and/or identified as a navigation hazard to river traffic based on Coast Guard and/or local standards, as applicable. The systems may not adversely affect the environment or local wildlife. The systems may not create any safety hazards. The systems may be scalable for adaptation to conditions of the waterway where it is to be deployed. The systems may be agnostic to the floating boom type and catch bin type. Parts of the system may be located on or connected to the shore. In one embodiment, as illustrated in FIG. 1A, the distance between moored buoy 102 and moored platform 116 may be approximately 193 m or 633 feet. Also, in one embodiment, the length of the beam/truss 110, catch bin 108 and end hinge 122 may be approximately 140 m or 460 ft. These embodiment measurements may also apply to the embodiments of FIGS. 1B and 1C.

Individual component descriptions of a multiple floating boom system may include the following:

Moored Buoy—A moored buoy may be anchored upstream and downstream of the rest of the structure using a mooring line as specified herein, and a mooring anchor as specified herein. The buoy may have at least two attachment points for two trash booms as specified herein to act as their upstream or downstream anchor. The attachment points are to be strong enough to withstand the forces exerted on them by the rest of the structure. The buoy may be clearly visible and marked as per the U.S. Coast Guard guidelines found in the U.S. AIDS TO NAVIGATION SYSTEM, as applicable.

Mooring Anchors—Mooring anchors or piles may be placed into or on the side or bottom of the waterway to fix the position of the system. Mooring anchors (or piles, if necessary) may be of sufficient strength and number to ensure the system does not become detached and drift away, even in intense waterway currents. They should also be located and designed carefully so as to not overly disturb the local ecosystem or the integrity of the sites where they are located.

Mooring Line—A mooring line is a line, rope, or chain or the like used to connect the mooring buoy and moored platform to the mooring anchors located at the riverbed. The mooring line may be of sufficient strength to withstand the forces it will undergo with sufficient length to allow the system to float on the surface of the waterway as the level changes (e.g., with tide), but without so much length that when the level is low that the system will be able to drift an unacceptable distance from its intended position.

Floating Booms—Floating booms can be shallow, flexible floating nets or structures used to redirect or capture floating litter, debris, oil/fuel and/or other pollutants into the catch bins. The floating booms can be connected upstream and downstream to the moored buoys and connected separately downstream or upstream to their respective outward hinges of the pivoting beams/trusses. The floating booms can be sourced from any one of a variety of manufacturers and should have an attachment with an acute angle with respect to the direction of the river flow at the mooring buoy. This angle may be larger than its attachment to the catch bins, as described herein. The first system of FIG. 1A may comprise floating booms positioned upstream, and the second system of FIG. 1B may comprise floating booms positioned both upstream and downstream.

Catch Bins—Catch bins may be used to collect or trap the floating pollutants redirected by the floating booms. Catch bins may be sourced from a bin designed to work with a standard floating trash/debris boom. The catch bins may vary depending on the needs of the river. The system may be designed to work with a variety of possible catch bins of assorted designs. The catch bin used should be of sufficient volume to store several days' worth of trash or debris that is captured by the system. The catch bins may also be able to collect and store/process floating oil. The catch bin should also be able to move laterally with the actuation of the pivoting beams/trusses. In some embodiments, the catch bins may include a gate on the end pivoting beam/trusses that can prevent the loss of trash in the case of tidal flow.

Pivoting Beams/Trusses—Pivoting beams/trusses can comprise structural members, hinged on both ends, that may be used to expand or collapse the floating booms and move the catch bins laterally in the river. The motion of the pivoting beams/trusses may be driven by the actuating lines or other torque generating methods. The structural members may be made from rigid and/or inflatable elements. The pivoting beams/trusses transmit lateral forces to the catch bins and floating booms to open or close the system. The pivoting beams/trusses may also be connected to or enclose one or more subsurface turbines. The pivoting beams/trusses must be of sufficient strength to withstand the drag forces exerted on its structure by the river and the positioning forces exerted on it by the actuating lines and trash boom. Floats may be included in the structure to provide sufficient net buoyancy as to counteract the combined weight of the pivoting beams/trusses and any other components which they may house. The pivoting beams/trusses may be clearly visible and marked as per the U.S. Coast Guard guidelines found in the U.S. AIDS TO NAVIGATION SYSTEM, as applicable. As used herein, “Pivoting Beams/Trusses” may be equivalent to “pivoting beam” or “beam/truss”.

Actuating Lines—An actuating line may be the upstream line and the downstream line. The actuating line may be comprised of a line, cable, rope, chain or the like used to actuate the system. The actuating lines should be selected to withstand the loads required to collapse and deploy the system, as well as hold the structure static as it undergoes drag forces caused by the river flow. The lines may have visible line floats that make the line clearly visible as per the U.S. Coast Guard guidelines found in the U.S. AIDS TO NAVIGATION SYSTEM, as applicable. The line material, with any braid and/or line floats, should be flexible enough to work with the actuating line spools as specified herein. The total length of the line may be longer than the length required for proper actuation of the system.

Actuating Line Motors—Actuating line motors may be used to extend or retract the actuating lines. The actuating line motors include motors and associated torque-multiplying transmissions. They provide enough torque to retract the actuation lines so that the system can deploy or collapse in a reasonable amount of time. Each motor may have electrical disconnects for servicing, and the central actuating cable may have a quick disconnect so that the system can be collapsed manually. Motors and transmission should be robust and rated to be used in a marine/riverine environment. Motors should be sized so that they can provide sufficient torque and power.

Actuating Line Spools—Actuating line spools may comprise a spool, winch, windlass, capstan or the like used to pull, release, and store the actuating lines as they may be retracted or extended. Actuating line spools should be sized so that they can roll up the entire length of the actuating lines with any line floats that may be attached. They should also be robust enough to withstand the torques exerted on them by the actuating lines and the actuating motors.

Shuttle—In some embodiments, for example, the second system of FIG. 1B may include a shuttle. The shuttle is a floating platform where the actuation lines (including their motors and spools), the control system, and the battery bank may be housed. It can have a sufficient net buoyancy to counteract the combined weight of all the components which it will house. The shuttle is attached to each beam/truss segment at the pivot point, and either retracts or extends actuation lines to facilitate the expansion/contraction of the pivoting beam/truss. The structure of the shuttle may be of sufficient strength to withstand both the static and dynamic forces exerted on it from, for example, actuating lines, mooring anchors, and river drag. As a summary, a shuttle is a floating platform where the sensor suite, battery bank, control system, power management system, actuating motors/spools may be located. The shuttle is positioned at the hinge of the pivoting beam. As is further discussed herein, the shuttle may comprise a single motor that is capable of pulling both a downstream line and the upstream line to cause the pivoting beams to close configuration and open configuration, wherein the downstream line is coupled from the shuttle to the moored platform and the upstream line is coupled from the shuttle to the moored buoy. The upstream line and downstream line may be a continuous line. In other embodiments, the shuttle may comprise more than one motor.

Moored Platform—In some embodiments, the first system may comprise a moored platform. A moored platform is a floating platform that may have different functions in different embodiments. In the first system, the moored platform is the floating platform where the sensor suite may be housed. It may also be connected to a subsurface turbine. It may have sufficient net buoyancy as to counteract the combined weight of all the components which it will house. The structure of the platform may have sufficient strength to withstand both the static and dynamic forces exerted on it from, for example, the floating booms, mooring anchor, and river drag. There may be appropriate lighting on the mooring platform. This lighting could, for example, indicate its stern, indicate what side is facing oncoming traffic, include a signal light indicating that the system is deploying or collapsing, and/or include a warning light if the system is unable to collapse. As a summary, a moored platform for the first system may be a floating platform where the sensor suite, battery bank, control system, power management system, actuating motors/spools may be located. The moored platform may be positioned downstream of the floating booms and the pivoting beam/truss. The moored platform may also include a subsurface turbine.

Moored Platform or Moored Buoy—Second system—A moored platform or moored buoy for the second system of FIG. 1B may be an optional floating platform for housing the sensor suite. It may also be connected to a subsurface turbine. It has sufficient net buoyancy as to counteract the combined weight of all the components which it will house. The structure of the platform may have sufficient strength to withstand both the static and dynamic forces exerted on it from, for example, the floating booms, mooring anchor, and river drag. There may be appropriate lighting on the mooring platform. This lighting could, for example, indicate its stern, indicate what side is facing oncoming traffic, include a signal light indicating that the system is deploying or collapsing, and/or include a warning light if the system is unable to collapse. As a summary, a moored platform for the second system is a floating platform where the collection system may be located and optionally the sensor suite and other elements may be located. A moored platform for the second system can be substituted for a mechanized trash collection conveyor, or a simple moored buoy. The moored platform for the second system can include downstream floating booms that may be attached to the moored platform to create a debris collection area. Hence, the moored platform for the second platform may be positioned downstream of the floating booms and the pivoting beam/truss. The moored platform or moored buoy in the second system may house the power generation. The moored platform or moored buoy in the second system may house a sensor suite with actuating equipment being on the shuttle, in some embodiments.

Subsurface Turbine(s)—The Subsurface Turbine(s) includes hydrokinetic turbines and associated energy conversion devices. The subsurface turbine(s) should be able to generate enough energy from the river and/or tidal currents at the systems deployed site so as to keep the battery bank charged to supply power to the various components of the system. The subsurface turbine(s) may be housed inside the pivoting beams/truss. They may be designed to rotate on the vertical axis so that they can convert energy from the river current regardless of their orientation relative to the river flow. A hydrokinetic turbine (current energy converter) may be optimized for use in low-flow rate settings, and used to generate power.

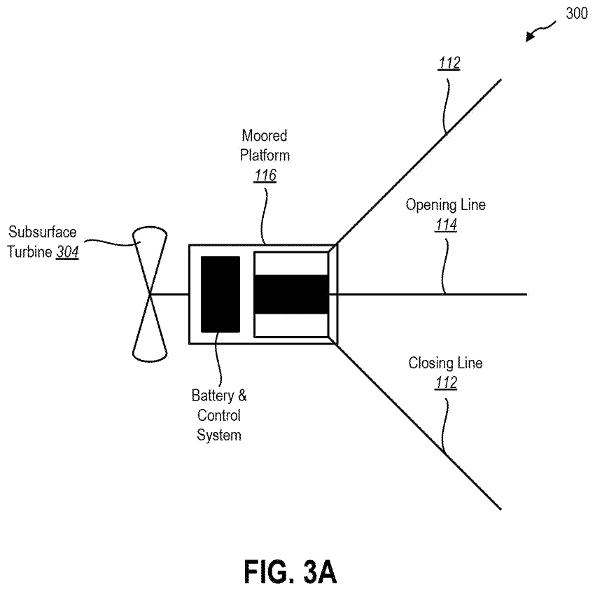

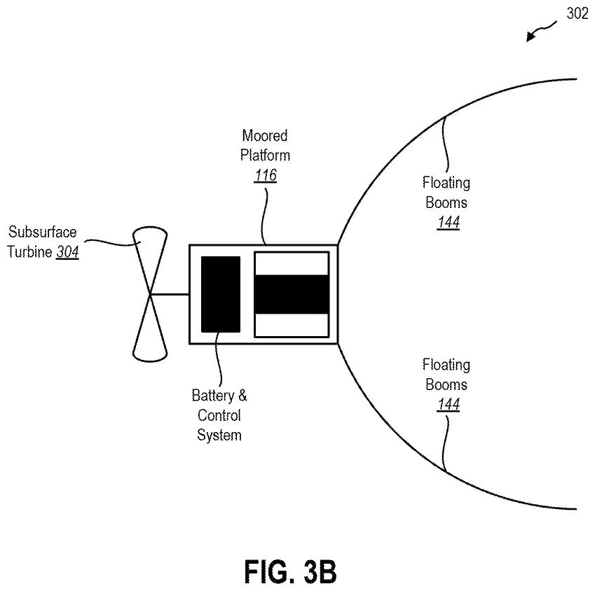

The first system is illustrated by FIGS. 1A, 1B and 3A. FIG. 1A depicts two system 100 with multiple floating booms 104 secured to a moored buoy 102 at a first end of the floating booms 104. FIG. 1A show an implementation of four floating booms 104. These floating booms may be located upstream relative to river flow 106. The floating booms 104 may be secured to a pivoting beam 110 at a second end of the floating booms 104. The system 100 is movable between an open configuration, as shown in FIG. 1A, and a closed configuration, as shown in FIG. 2A. In the open configuration shown in FIG. 1A, the floating booms 104 may guide floating pollutants 118 into catch bins 108 located at the lateral end of the pivoting trusses. Two systems 100 are shown in FIG. 1A side by side. The actual size of each system 100 will vary based on the width of the waterway, whether the waterway is navigable by boats, the size of any boats that may navigate the waterway, a desired catch rate for pollutants 118, the amount and size of pollutants 118 in the waterway, and the like. As used herein, “catch bins 108” may be equivalent to “catch bin 108”. As used herein, “floating boom 104” may be equivalent to “floating booms 104”. As used herein, “river flow 106” may be equivalent to “water flow direction 106”. As used herein, “pivoting beam/truss 110 may be equivalent to “pivoting beams 110”, or to “one or more pivoting trusses/beam 110”.

The disclosed system 100 works in large waterways with substantial floating debris and vessel traffic. The disclosed system works in waterways where the flow periodically reverses. This reversal may come, for example, from tidal flows. If the flow reverses (i.e., if the waterway flows inland-ward in a reverse direction from that shown in FIG. 1A), the system 100 may not catch new pollutants 118 during the period of reversed flow. Rather, the system may retain pollutants 118 that were in the respective catch bins 108 before the flow reversed. The catch bins 108 may be designed in such a way that they passively prevent substantial backflow of the pollutants 118. Alternatively, the catch bins 108 may actively reconfigure themselves at the commencement of reverse flow to prevent the escape of pollutants 118. For example, the catch bins 108 may include a hinged door or gate. When the water flow direction 106 flows from the moored buoy 102, across the floating booms 104, and to the pivoting beams 110, the water flow in the water flow direction 106 may cause the gate to open, thereby allowing the pollutants 118 to enter the catch bins 108. When the water flow direction 106 reverses and flows from the catch bins 108 toward the moored buoy 102 (e.g., bottom to top in FIG. 1A), the water flow may cause the hinged gate to close, thereby preventing the pollutants 118 entrained by the catch bins 108 from flowing out of the catch bins 108. In this manner, when the flow is not reversed (e.g., when the waterway flows downstream in the water flow direction 106, or from top to bottom as shown in FIG. 1A), the system is able to collect pollutants 118 that otherwise would have progressed further downstream towards the ocean or a larger body of water.

In some embodiments, as discussed in further detail herein, the moored buoy 102 may be moored or anchored to a stationary object. For example, the moored buoy 102 may be moored or anchored to the bed under the water, a rock, the shore, a bridge pylon, an anchor on the bed, or otherwise anchored to a stationary object. In some embodiments, the moored buoy 102 may not be moored or anchored to a stationary object. For example, the moored buoy 102 may be secured to, a vessel that tows or carries the system 100 to a desired location for use. In such a case, the vessel may anchor itself while the system is in use. If the vessel is anchored while the system 100 is in use, the moored platform 116 may also be anchored at a distance downstream from the vessel. Alternatively, a vessel acting as the moored buoy 102 may not be anchored or moored while the system is in use. In such an embodiment, the vessel may tow the system 100 through a waterway or larger body of water such as the ocean to create relative flow between the floating booms 104 and the water to redirect pollutants 118 near the water surface into the catch bins 108.

The disclosed system 100 may collect floating trash and other debris/pollutants 118 in the highest levels of the water column. The floating booms 104 and respective catch bins 108 may include submerged portions. The submerged portions of the floating booms 104 allows them to redirect pollutants 118 which are moved by the current downstream laterally towards the catch bins 108 even when the pollutants 118 have a low buoyancy or may be wholly or partially below the surface of the water. The submerged portions of the floating boom 104 also help prevent pollutants 118 from flowing under the floating boom 104 instead of being captured by the respective catch bin 108. The submerged portion of the respective catch bins 108 may also help capture pollutants 118 that have a low buoyancy or that may be wholly or partially below the surface of the water.

The disclosed system 100 may store the collected pollutants 118 in one or more catch bins 108 until the pollutants 118 can be properly disposed of. The system may be designed to facilitate the processing of pollutants 118 that were collected in the catch bins 108.

In some embodiments, the disclosed system 100 may be made of materials that can withstand a riverine/marine environment for extended periods of time. These materials may include metals that are alloyed for use in corrosive environments (e.g., saline ocean water, chemically polluted water). These materials may also include polymers that are stable under prolonged exposure to ultraviolet radiation from the sun. In some embodiments, sensitive materials such as electronics may be protected by enclosing them in more robust materials.

The disclosed system 100 may include one or more components that are clearly marked and/or identified as a navigation hazard to waterway traffic based on Coast Guard and/or local standards, as applicable.

The disclosed system may not adversely affect the environment or local wildlife. The system 100 may be designed so that it does not release harmful pollutants into the environment. The system may be designed so that animals can easily swim below it (e.g., the floating booms 104 may not extend to the bed below the surface of the water), fly above it, or circumnavigate around it without any danger to themselves or the structures of the system 100. The system 100 may be designed so that it minimizes any disturbance to the ecosystem of the bed or shore of the riverway.

The disclosed system may not create any safety hazards to traffic (e.g., motorized watercraft, non-motorized watercraft, swimmers, waders) on the water. The system 100 may have brightly colored markings, reflective markings/materials, features elevated above the surface of the water, and/or illumination to increase its visibility. The system 100 may include highly reflective elements such as ball reflectors to increase its radar cross section. Such markings may be placed on any portion of the system 100. For example, such markings may be placed on the floating booms 104, the pivoting beams 110, the catch bins 108, the moored platform 116, the opening line 114, the closing lines 112, any other portion of the system 100, and combinations thereof. In some embodiments, the markings may be placed on a portion of the system 100 that is exposed above the surface of the water. In some embodiments, the markings may be placed on a portion of the system that is at least partially submerged under the water. In some embodiments, the markings may be placed on a portion of the system that is submerged and uncovered by fluctuating water levels (e.g., due to tides, seasonal runoff, dam release). In some embodiments, the system 100 may have an Automatic Identification System (AIS) transmitter to broadcast the position of the system to nearby vessels with a radio signal.

The disclosed system 100 may be scalable for adaptation to conditions of the waterway where it is to be deployed. In some embodiments, this may be done by changing the lengths of the floating boom 104, the beam/truss 110, the opening line 114, and/or the closing lines 112. Changing the lengths of the floating booms 104 may cause the arc between the moored buoy 102 and the catch bins 108 to change in shape, which may be based on the flow velocity of the water, the distance between the moored buoy 102 and the catch bins 108, or any other factor. The width of the system 100 when open may be large relative to the width of the waterway to capture pollutants 118 distributed throughout a wide portion of the waterway. For example, the open width (e.g., the distance between the catch bins 108 connected to the pivoting beams 110, the lateral distance from the moored buoy 102 to the catch bins 108) may span an entirety of a waterway. In some examples, the open width may span less than an entirety of the waterway. For example, the width of the system 100, when open, may be sized to a width of the waterway where pollutants 118 are prevalent. In some examples, this width may be less than the entire width of the waterway. In some embodiments, such as the embodiment shown in FIG. 1A, two or more systems 100 could be deployed side by side or at different positions upstream and downstream from one another to effectively capture pollutants 118 in different parts of the waterway and/or to accommodate other waterway needs such as vessel traffic.

In some embodiments, the disclosed system 100 may be agnostic to the floating boom 104 type and catch bin 108 type. In some embodiments, the floating boom 104 may need to be modified compared to booms used in other settings to be able to support the large tensile forces that it may be subjected to. For example, the floating booms 104 may be formed from a material that is designed to withstand forces caused by the fluid velocity of the fluid flow, the impact of the pollutants 118 with the floating booms 104, waves, reversing flow direction, any other force, and combinations thereof. In some embodiments, the catch bin 108 may be selected from catch bins that were designed to collect pollutants 118 that are redirected to by floating booms similar to 104 but with systems that do not have an open and closed configuration such as in the disclosed system. It may be desirable for the catch bins 108 to be able to hold or process a large quantity of pollutants 118 before such pollutants are removed from the catch bin 108. It may be desirable for the catch bins 108 to be designed so that they minimize the drag forces from the river current, thus reducing the forces that are transmitted to other parts of the system 100.

The disclosed system 100 may include one or more moored buoys 102. Each moored buoy 102 may be located upstream relative to water flow direction 106. The moored buoy 102 may anchor converging ends of one or more floating booms 104. The moored buoy 102 may be anchored upstream of the rest of the structure in the disclosed system 100 using a mooring line (not shown) and a mooring anchor (not shown). Alternatively, the moored buoy 102 may be attached to the pylon of a bridge, to existing river structures, to a mooring pile, to a structure above the surface that is commonly referred to as a dolphin structure, to the shore, to a river island, to the corner of a river confluence, to a fork in the river, and/or to some other immovable structure. The moored buoy 102 may have at least two attachment points for two floating booms 104 to act as their upstream anchor. The attachment points may be strong enough to withstand the forces exerted on it by the rest of the structure. The buoy may be clearly visible and marked as per applicable local regulations, which may include the U.S. Coast Guard guidelines found in the U.S. AIDS TO NAVIGATION SYSTEM.

One or more mooring anchors (not shown) may be anchors or piles placed into or on the side or bottom of the waterway to fix the position of the moored buoy 102 and accordingly the position of the system 100. The mooring anchors may be selected from or designed based on the conditions of the bed of the waterway where the system is deployed. Mooring anchors (or piles, if necessary) may be of sufficient strength and number to ensure the moored buoy 102 and system 100 do not become detached and drift away, even in intense waterway currents. The one or more mooring anchors may be located and designed carefully as to not overly disturb the local ecosystem or the integrity of the sites where they are located.

One or more mooring lines (not shown) may be lines, ropes, chains, or the like used to connect to the moored buoy 102 and/or a moored platform 116 to the one or more mooring anchors located at the bed of the waterway. The mooring line may be of sufficient strength to withstand the forces it will undergo with sufficient length to allow the system 100 to float on the surface of the waterway as the level changes (e.g., with tide), but without so much length that when the level is low that the system will be able to drift an unacceptable distance from its intended position.

One or more floating booms 104 may be shallow, flexible floating nets or structures used to redirect and/or capture floating litter, debris, oil/fuel and/or other pollutants 118 into the respective catch bins 108. Each floating boom 104 may be connected upstream to a respective moored buoy 102 and connected separately downstream to a respective outward hinge of a respective pivoting beam/truss 110. The floating booms 104 may attach to the moored buoy 102 with an acute angle with respect to the flow direction 106 of the waterway flow at the moored buoy 102. This angle may be larger than the attachment of floating booms 104 to the respective catch bins 108.

One or more litter traps or catch bins 108 may be bins used to collect or trap the floating pollutants 118 redirected by the respective one or more floating booms 104. The one or more catch bins 108 may be designed to work with a floating trash/debris boom. The one or more catch bins 108 may vary depending on the needs of the waterway. The system 100 may be designed to work with a variety of possible catch bins 108 of assorted designs and/or sizes. The catch bins 108 used may be of sufficient volume to store several days worth of trash, debris, and/or pollutants 118 that are captured by the system 100. The catch bins 108 may also be able to collect, store, and/or process floating oil. The processing of the oil may use commercial oil skimmer technology. The catch bin 108 may be able to move laterally with the actuation of the pivoting beams/trusses 110.

One or more pivoting beams/trusses 110 may be structural members, hinged on both ends via respective center hinges 120 and end hinges 122, that are used to expand or collapse the one or more floating booms 104 and move the one or more catch bins 108 laterally relative to a water flow direction 106 of the waterway. The motion of the pivoting beams/trusses 110 may be driven by the actuating lines or other torque generating methods. The structural members may be made from rigid, tensile, and/or inflatable elements, including a combination of those element types. For example, the pivoting beams/trusses 110 may be made from sections of truss frame designed for floating docks. Alternatively, for example, the pivoting beams/trusses 110 may be made from arrangements of approximately tubular lengths of pneumatically inflated sections, such as those that are used for floating water parks or what are referred to as “rigid inflatable boats” (RIB). The one or more pivoting beams/trusses 110 may transmit lateral forces to the one or more catch bins 108 and one or more floating booms 104 to move the system 100 between an open configuration (FIG. 1A) and a closed configuration (FIG. 2A).

In some embodiments, the angles of the beams/trusses 110 in the open (FIG. 1A) and closed (FIG. 2A) configurations may be different than those depicted in the figures. For example, when open (FIG. 1A), the principal length of the beams/trusses 110 may not be fully perpendicular to the flow direction and, when closed (FIG. 2A) the principal length of the beams/trusses 110 may not be fully parallel to the flow direction.

In some embodiments, the pivoting beams/trusses 110 or the moored platform 116 may also be connected to one or more sources of power generation. Compared to the moored platform, the beams/trusses may be an advantageous location because they may occupy a larger area of the waterway, facilitating the generation of more power. The beams/trusses 110 may be able to hold more solar panels than could be practically attached to the moored platform. In some embodiments, the system may generate more energy than is needed for its own use. In such a case, the power may be conveyed from the system for other purposes. The export of power could increase the value of the system.

The large width of the beam/trusses 110 when the system 100 is in an open configuration is especially advantageous for a hydrokinetic generation system. For example, when the system is in an open configuration (FIG. 1A), the beams/trusses 110 span a relatively large width of the river, increasing the amount of hydrokinetic energy that can be extracted from the river, compared to a system that spanned a narrower width of the river. This is because the amount of hydrokinetic energy that can be extracted from a river is proportional to the cross-sectional area of the flow that the turbine interacts with. Whereas it may be difficult to obtain permission for a hydrokinetic system that permanently obstructs a large width of a waterway, the systems and methods described herein could be used to create hydrokinetic power systems that are able to span large widths of a waterway but then move to a closed configuration, as needed. The system 100 could close, for example, to allow a boat to pass unimpeded (as shown in FIG. 2A).

The sources of power generation connected to parts of the system could include photovoltaic solar panels, wind turbines, and/or hydrokinetic current energy converters. The hydrokinetic current energy converters could be, for example, subsurface turbines or water wheel like devices. The beams/trusses could also include subsurface mesh, net, grid, or grate-like structures to prevent debris or fish from interacting with a turbine. The controllable pivoting of the beams/trusses could also be used to limit the forces experienced by subsurface turbines. For example, in high flow rates, a turbine that is designed to generate power in one orientation could be rotated approximately 90 degrees from that orientation to protect the turbine. Alternatively, a vertical-axis hydrokinetic turbine could be used so that power could be generated regardless of the orientation of the beams/trusses 110.

The pivoting beams/trusses 110 must be of sufficient strength to withstand the drag forces exerted on their structure by the waterway and the positioning forces exerted on it by the actuating lines and one or more catch bins 108. In some embodiments, floats (not shown) may be included in the structure to provide sufficient net buoyancy as to counteract the combined weight of the pivoting beams/trusses 110 and any other components which they may house. These floats may be selected from float types used for docks or boats. The pivoting beams/trusses 110 may be clearly visible and marked as per applicable local regulations or guidelines, including the U.S. Coast Guard guidelines found in the U.S. AIDS TO NAVIGATION SYSTEM, as applicable. These markings could include bright colors, reflective markings, and/or powered lighting.

Actuating lines may include an opening line 114 and a closing line 112. The actuating lines may include line, cable, rope, chain, or the like used to actuate the system 100. The actuating lines may be selected to withstand the loads required to move the system 100 between an open configuration (FIG. 1A) and a closed configuration (FIG. 2A), as well as hold the structure static as it undergoes drag forces caused by the waterway flow. The actuating lines may have visible line floats (not shown) that make the actuating lines clearly visible per any applicable local regulations. Such floats may be selected from among commercially available options. The actuating lines may include visually reflective material to be visible above the water. The lines may be connected in a way so that they are more visible by being elevated above the water surface. The actuating lines material, with any braid and/or line floats, may be flexible enough to work with actuating line spools. A total length of the actuating lines may be longer than the length required for proper actuation of the system 100.

In one embodiment, the system 100 may have two closing lines 112. Each closing line 112 may be attached to the moored platform 116 at a first end and attached to the catch bin 108 and/or pivoting beam/truss 110 at a second end. The second end of each closing line 112 may be proximate end hinges 122 of the pivoting beam/truss 110. In one embodiment, the system 100 may have one opening line 114. The opening line 114 may be attached to the moored platform 116 at a first end and attached to the pivoting beam/truss 110 at a second end. The second end of the opening line 114 may be proximate the center hinges 120 of the pivoting beam/truss 110. Exerting a force on the opening line 114, such as by reeling in the opening line 114 via one or more actuating line motors (e.g., an opening line motor for the opening line 114, a closing line motor for the closing line 112), may cause the system 100 to enter an open configuration, as shown in FIG. 1A. Exerting a force on the closing lines 112, such as by reeling in the closing lines 112 via one or more actuating line motors, may cause the system 100 to enter a closed configuration, as shown in FIG. 2A. In some embodiments, extending the opening line 114 and retracting the closing line 112 may cause the system 100 to move into the open position, while retracting the opening line 114 and extending the closing lines 112 may cause the 100 to move into the closed position.

Alternatively, half of the system 100 may be partially closed by retracting one the closing lines 112 more than another. This approach could, for example, allow a vessel to pass on one side of the system 100 without closing both sides completely. In this approach, the forces on the beams/trusses 110 would no longer be symmetric and the junction between them may move away from the center.

One or more actuating line motors (e.g., an opening actuator and/or a closing actuator, not shown) may be motors used to extend or retract the actuating lines. The actuating line motors may include motors and associated torque-multiplying transmissions selected from among commercially available components. The actuating line motors may provide enough torque to retract the actuation lines so that the system 100 can switch between an open configuration (FIG. 1A) or a closed configuration (FIG. 2A) in a reasonable amount of time. Each motor may have electrical disconnects for servicing, and the central actuating cable may have a quick disconnect so that the system can be collapsed manually. Motors and transmission may be robust and rated to be used in a marine/riverine environment. Motors may be sized so that they can provide sufficient torque and power.

One or more actuating line spools may be spools, windlass, capstan, or the like used to pull, release, and store the actuating lines as they are retracted or extended. The spools may be selected from among standard commercially available components including marine winches and/or land vehicles. They may be closely integrated with the actuating motor and transmission in devices sold as a single unit. Actuating line spools may be sized so that they can roll up the entire length of the actuating lines with any line floats that may be attached. The actuating line spools may be robust enough to withstand the torques exerted on them by the actuating lines and the actuating motors.

The actuating motors may be controlled to manage the extension and retraction of the actuating lines. This control may include line length control and/or force/tension control. For example, when closing the system, the length of the retracting closing lines 112 may be actively controlled while the tension on the extending opening line 114 may be controlled to an appropriately small value. When opening the system, the length of the retracting opening line 114 may be actively controlled while the tension in the extending closing lines 112 may be controlled to an appropriately small value. The deployed length of an actuating line may be measured by measuring the rotation of the actuating line spool or by measuring the rotation of another element that rotates with the extension and retraction of the actuating line. This measurement may be used to control the inputs of the actuating motor and, through the motion of the actuating line, the motion of the system 100.

In some embodiments, a certain amount of tension may be maintained in the lines. This may prevent tangling in the actuating line spools. This tension may be measured and maintained, for example, by an articulating lever arm with a freely rotating wheel (not shown) that is spring-loaded to apply tension to the actuating line. The lever arm may be designed so that when the actuating line far from the spool is slack, the lever articulates to an angle that applies pressure between the line and some other high friction surface, preventing the line closer to the spool from accumulating large amounts of slack. The lever arm may be arranged so that when the actuating line is under increased tension, the arm rotates away from the high friction surface, allowing the line to move freely as it turns the wheel on the lever arm. The angle of the arm may be measured to facilitate the active control of the tension in the actuating line via the inputs applied to the actuating motor.

One or more moored platforms 116 may be a floating platform where a sensor suite, battery bank, control system, power management system, actuating motors, and actuating spools are located. The moored platform 116 may be positioned downstream, relative to the water flow direction 106, of the one or more floating booms 104, and the one or more pivoting trusses/beam 110. In some embodiments, the moored platform 116 may include a subsurface turbine 304 (See FIG. 3A).

The moored platform 116 may be the floating platform where the actuating lines (including their motors and spools), the control system, the sensor suite, and the battery bank may be housed. These elements may be collectively located in FIGS. 3A and 3B as Battery & Control System 306. The moored platform 116 may have sufficient net buoyancy as to counteract the combined weight of all the components which it will house. The structure of the platform may be of sufficient strength to withstand both the static and dynamic forces exerted on it from, for example, the actuating lines, mooring anchor, and waterway flow drag.

In embodiments where more power generators are connected to the beams/trusses 110 than the moored platform 116, it may be preferable to move the major components from the moored platform 116 to the beams/trusses 110. This could include, for example, the control system, the battery bank, and the actuating line motors. If the actuating line motors were moved to the beams/trusses 110 the function of the moored platform 116 may be simplified so that its principal function is to act as a static connection point to the actuating lines, similar to the way in which the moored buoy 102 acts as a connection point for the floating booms 104.

In some embodiments, there may be appropriate lighting (not shown) on the mooring platform. This lighting may, for example, indicate its stern, indicate what side is facing oncoming traffic, include a signal light indicating that the system is deploying or collapsing, and/or include a warning light if the system is unable to collapse.

The disclosed system 100 provides an automated dynamic way to reversibly span the surface of a waterway. The purpose of the span may be, for example, to deploy one or more floating booms 104 and one or more catch bins 108 to redirect and capture floating litter, oil, and/or pollutants 118 before it reaches a terminus of the waterway. The span may also be used to expose turbines to the hydrokinetic energy of the waterway.

In the open or spanning configuration as shown in FIG. 1A, the disclosed system 100 can use one or more floating booms 104 to guide floating litter, oil, and/or pollutants 118 into one or more catch bins 108 or garbage traps. Hydrokinetic turbine(s) (or current energy converter(s)) may also be connected to the system 100 to capture energy from the waterway. The spanning of the system may expose these turbines to a greater cross-sectional area of the waterway, with correspondingly greater convertible energy. The system 100 can be designed to be symmetric, as shown in FIGS. 1A and 2A. This symmetric configuration may be useful for mid-waterway deployments.

FIG. 2A depicts the systems 100 of FIG. 1A in a closed configuration 200 where width is reduced to allow boat traffic 202 to traverse the waterway unimpeded. In some embodiments, using the sensor suite described herein, the disclosed system 100 detects, tracks and appropriately responds to proximal surface traffic in the waterway. In the closed configuration 200, the system 100 widths may be reduced to allow boat traffic 202 to traverse the waterway unimpeded. Actual size of the systems 100 may vary. When the systems 100 detect impending ships and small boats (e.g., boat traffic 202), a collapsing sequence may be triggered that allows the assembly to fold into itself and clear the path for the boat traffic 202. The dimensions of the systems 100 may vary from those shown herein. The large dimensions depicted herein illustrate how the system could be large enough to allow 50-meter-wide vessels, for example, boat traffic 202, to pass between two instances of the system 100. As illustrated in FIG. 2A, in one embodiment, the width of each floating beam structure is approximately 25 m, or 82 ft.

The quantity of pollutants 118 that can be collected by the system 100 depends on the capacity of the catch bins 108 and the width of the floating boom 104. When the system is in an open configuration (as in FIG. 1A), a greater quantity of pollutants 118 will be redirected into the catch bins 108 and captured by the catch bins 108, compared to when the system is in a closed configuration 200 (as in FIG. 2A). Thus, to collect the greatest quantity of pollutants 118 the system 100 may remain in an open configuration for as much of the time as is reasonable without impeding surface traffic.

Besides impeding surface traffic, there may be other factors considered by the control system to determine when the system 100 should be in an open configuration or a closed configuration 200. During times following heavy rainfall, the quantity of pollutants in the river may be greater than at other times, making the open configuration of the system 100 especially useful. During times of high river flow, the forces on the system 100 are larger in the open configuration than in the closed configuration 200. At certain flowrates, the control system may determine to move the system into a closed configuration 200 to prevent the system from becoming damaged from high flowrates. The control system may also consider external inputs which directly command the system 100 to move to an open or closed configuration.

FIG. 3A depicts a close-up view 300 of the moored platform 116 in the system of FIG. 1A. The moored platform 116 may include a sensor suite, battery bank control system and drives for the actuating lines. These items are indicated battery & control system 306 in FIG. 3A. The moored platform 116 may also include a subsurface turbine 304. In some embodiments, the system may be powered by harnessing the hydrokinetic energy of the waterway where it is deployed. In some embodiments, the system may covert additional hydrokinetic energy, beyond its own needs, for other uses and/or external transmission.

When boat traffic has passed, the system may redeploy and resume operations. This actuation is accomplished with cables powered by electric motors located on the moored platform 116. The system may be powered by a hydrokinetic turbine, solar energy, and/or shore-based power. If shore-based power is used, an electrical cable conveying the power may be run along the bottom of the waterway to the moored platform. If the system is to be used at a moderate latitude with sunshine in all seasons, solar power may be the most practical power source. If the system is to be used at an extreme latitude, or at a site with relatively constant fast flowing current, a hydrokinetic turbine may be the most practical power source.

The one or more subsurface turbines 304 may be a hydrokinetic turbine (current energy converter). In some embodiments, the subsurface turbine 304 may be optimized for use in low-flow-rate settings and may be used to generate power. The subsurface turbine 304 may include hydrokinetic turbines and associated energy conversion devices. The subsurface turbine 304 may be able to generate enough energy from the waterway and/or tidal currents at the systems deployed site to keep the battery bank (not shown) charged to supply power to the various components of the system. The subsurface turbines 304 may be designed to rotate on the vertical axis so that they can convert energy from the waterway current regardless of their orientation relative to the waterway flow.

In some embodiments, one or more subsurface turbines may be housed inside the one or more pivoting trusses/beams (See FIGS. 1A-2B).

A battery bank (not shown) may be a load-balancing electrical storage to provide system power in instances when the subsurface turbine 304 has no power generation. i.e., high tide, maintenance, etc. The battery bank may be of sufficient size to provide continuous power to the entire system, including providing enough power for intermittent use of the actuating line motors. The battery bank may be assembled and designed to operate safely in a wet environment. The battery bank needs to have a large enough capacity to store power from any intermittent power sources such as a hydrokinetic turbine or photovoltaic solar panel array. Such sources of power may produce substantial power for only a few hours each day. In the case of solar panels, there may be cloudy days where very little power is generated. The battery bank may be sized to provide power to the system as needed until a sunny day is able to recharge the battery bank. The battery bank may need to be able to support relatively large electrical currents for the actuating line motors.

A sensor suite (not shown) may be used to detect and track ships and detect and identify trash and debris. The sensor suite may be located on the moored platform 116, on/near the beams/trusses 110, near the system on another floating element, and/or on the shore near the system. The purpose of this sensor suite is to help the control system determine whether it is appropriate or not to move the system into an open configuration. The sensor suite may communicate with the control system with a wired or wireless (e.g., radio) method. If a wireless method is used, the communication method may use appropriate security methods such as encryption to avoid spoofing. If the control system has not received a recent signal from the sensor suite indicating that it is appropriate for the system to be in an open configuration, the control system may close the system or leave the system in a closed configuration. The control system may be able to open in the absence of recent information from the sensor suite with appropriate overrides.

In some embodiments, the sensor suite may measure weather conditions or the current in the river. It may measure the weather directly or it may obtain weather information through an internet/cellular connection.

The senor suite may include a Marine RADAR system, mm-Wave radar, digital compass, visual/near-infrared camera(s), LIDAR, proximity sensors, laser/optical tripwires, GPS location system, VHF radio, and/or an Automatic Identification System (AIS) transceiver. The Marine RADAR system may be capable of detecting and tracking both large and small vessel traffic. The RADAR's minimum range may be twice the minimum distance required for the system to fully collapse before the vessel reaches its location while the vessel maintains its initially detected speed. The Vessel AIS receiver should be capable of receiving all AIS signals from nearby ships. It may also be capable of transmitting its own signal and location to nearby ships. The GPS location system can integrate with the AIS Transceiver and RADAR to allow the sensor suite to accurately detect, identify, and track the positions and trajectories of impeding waterway surface traffic.

The sensor suite used to detect the impeding shore traffic may be located on the shore of the waterway or they may be part of the moored system. The system could use other methods to govern the opening and closing of the span, including time-based systems and operator-based control.

A control system (not shown) may use input data from the sensor suite along with position input from the actuation line motors to switch between an open configuration (FIG. 1A) or a closed configuration (FIG. 2A) in a reasonable amount of time to avoid impeding waterway traffic. The control system may control the deployment and collapsing of the system using: information from the sensor suite; information from a power management system; and/or position information measured at the actuating line spools.

When the sensor suite detects impending boat traffic, the control system may activate the actuating motors so that the system collapses to the closed configuration (FIG. 2A). When no impending traffic is detected the Control System may signal the actuating motors to deploy the pivoting beams/trusses to an open configuration (FIG. 1A). Alternatively, the deployment/collapsing of the system may be based on other factors including, for example, the time of day or inputs from a remote operator.

The control system may also include a wireless connection to enable remote control and monitoring of the system; and a human-accessible control panel with, for example, an E-Stop, disconnects, and/or status indication lights.

The control system may use visual and auditory cues (e.g., flashing lights and/or horn blasts) for safety reasons and to indicate that it is about to open or close or in the process of opening or closing. It may also use a VHF radio transmission for the same purposes. In doing so, it may follow conventions associated with other devices that make passage for boats, such as a draw bridge.

A power management system (not shown) may be used to manage the power generation from the subsurface turbine(s) 304, the power storage in the battery bank, and the power supply to the control system, sensor suite, and actuating line motors. In some embodiments, the power management system may also send excess energy to other uses, including onshore. The power management system may be able to measure power generation from the subsurface turbine(s) 304, measure battery bank charge, and, through the control system, dynamically regulate how frequently the system deploys and collapses based on available battery bank charge. If the battery bank charge falls below the required threshold to be able to deploy and then collapses again, the system may remain closed until sufficient stored power is available. The power management system may also help control the distribution of excess energy to other needs, including external use.

The second system is depicted by FIGS. 1B, 2B and 3B. FIG. 1B discloses system 140 that includes modifications to system 100 of FIG. 1A. System 140 comprises two floating beam structures. The objectives of these modifications are to increase the waste capacity, while maintaining the ability to fold into a narrow space to allow boat traffic to pass the system. The design of the first system includes upstream floating booms. The waste that is carried by the river downstream can be deflected by these booms into these catch bins, which have a certain volume.

In accordance with at least one embodiment of the present disclosure, the system 140 may include downstream floating booms 144, the catch bin 148 that acts as a gate, allowing the debris to flow through it to the collection area created by the downstream floating booms 144, floats 162 secured to the beam/truss 110, shuttle 160 connected to the beam/truss 110 and make features optional for the moored platform 156. These features will be subsequently discussed.

As described, system 140 of FIG. 1B adds one or more floating boom 144 on the end of beam/truss 110 for collecting the waste. So, waste collection is not limited to the catch bin. Additionally, gates (not shown) may be located at the end of the beam/truss 110 and incorporated into catch bin 108. The river flow pushes the waste down, the waste gets deflected by these floating booms 104 and the waste enters these gates and then the waste is collected in an area defined by the one or more floating boom 144. The advantage of this system/method is that it is not just the area behind the beam/truss 110 that is the collection, but in the event of tidal flow, the floating boom 144 that were initially used to deflect the trash can now also keep the trash inside the system from escaping. These gates can include a closing mechanism. The other end of the one or more floating boom 144 may be attached to the moored platform 156.

The system 140 may facilitate a reduction in the required number of winches or pullies. Instead of three winches or three pulleys to open and close the system the second system design only requires one pulley to open and close the system. The second system connects directly to the moored buoy 102, which is located upstream, and then to the moored platform 156, which is located downstream.

As illustrated, FIG. 1B includes a shuttle 160. As previously discussed, the shuttle 160 is a floating platform where the sensor suite, battery bank, control system, power management system, and actuating motors/spools may be located. The shuttle 160 is positioned at the hinge of the pivoting beam. As previously noted, the shuttle 160 can have a sufficient net buoyancy as to counteract the combined weight of all the components which may be housed in the shuttle 160. The shuttle 160 is attached to each beam/truss 110 segment at the pivot point, and either may retract or extend actuation lines to facilitate the expansion/contraction of the pivoting beam/truss 110. The structure of the shuttle 160 may be of sufficient strength to withstand both the static and dynamic forces exerted on it. Located between the shuttle 160 and the moored platform 158 may be downstream line 142. Located between the shuttle 160 and the moored buoy 102 is upstream line 143. The shuttle 160 can comprise one motor that pulls both the downstream line 142 and the upstream line 143. Which simplifies the closing/opening mechanism. As such the shuttle 160 is pulling in the upstream line 143 and letting out the downstream line 142 to achieve the desired length. In other words, if the motor pulls the upstream line 143, it will be letting out the downstream line 142 and the floating structure will close. And when the process is reversed, and the downstream line 142 is pulled in, the upstream line 143 will be let out and the system will be open. In this configuration the downstream line 142 will be in its shortest configuration and the upstream line 143 will in in its longest configuration. In some embodiments, the upstream line 143 and downstream line 142 may be a continuous line. In various embodiments, the lines described herein could be a cable, rope, or chain.

In this manner, the actuation is controlled by the shuttle 160, instead of the moored platform 116, as described for FIG. 1A. Alternatively, the shuttle 160 can comprise two motors, where one motor pulls the downstream line 142 and the other motor pulls the upstream line 143.

As illustrated, FIG. 1B includes a number of floats 162 located in the cross structure of the pivoting beam/truss 110. This number of floats 162 provides additional structure in the second system to support the requirements presented by the shuttle 160 and floating booms 144.

As illustrated, FIG. 1B may include a moored platform 156. As previously discussed herein, the moored platform 156 for the second system, per FIG. 1B, is a floating platform that may optionally house the sensor suite and other components. In the first system, most of the components may be located in the moored platform 116. In the second system, many of the components may be re-located to the shuttle 160, including actuating lines, motors, spools, the control system and battery banks. The sensor suite may also be located on the shuttle 160. The moored platform 156 may provide support for downstream floating booms 144.

FIG. 1C depicts another embodiment 150 of the second system with two multiple floating booms in a partially closed configuration. As illustrated, floats 162 are being configured, i.e., folded, to allow vessels to travel up/down the waterway.

FIG. 2B depicts the second system in a closed configuration where width is reduced to allow boat traffic to traverse the waterway unimpeded, according to one embodiment. More specifically, FIG. 2B depicts the system 140 of FIG. 1B in a closed configuration 240 where width is reduced to allow boat traffic 202 to traverse the waterway unimpeded. As illustrated, system 140 comprises floating boom 104, floating booms 144 and floats 162 that may be positioned within the beam/truss 110.

FIG. 3B depicts a close-up view 302 of the moored platform in the second system of FIG. 1B, according to one embodiment, FIG. 3B includes the same elements as FIG. 3A except instead of opening line 114 and closing line 112, FIG. 3B includes the two floating booms 144 that are coupled to the moored platform 156.

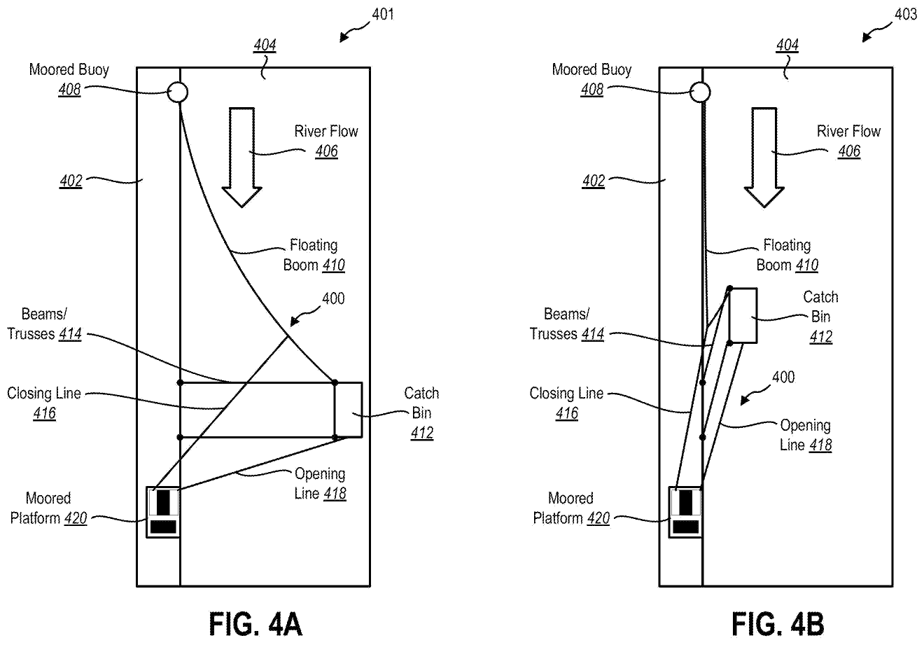

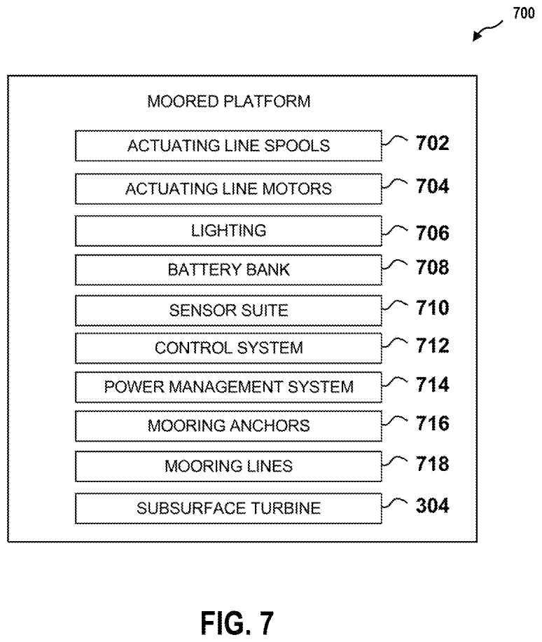

FIGS. 4A-4B, 5A-5D, 6 and 9-11 apply to the first system (FIG. 1A, 1B, 1C 3A) and the second system (FIG. 1B, 2B, 3B). FIG. 7 only applies to the first system (FIG. 1A, 2A, 3B), as will be subsequently discussed.

FIG. 4A depicts an alternate system 400 in an open configuration 401 for guiding floating pollutants into a catch bin 412. Parts of this alternate system may be located on or connected to the shore. In some embodiments, this alternate system 400 may be asymmetric, use one or more Beams/Trusses 414, and/or be connected to the shore.

The disclosed alternate system 400 may have one or more beams/trusses 414, be asymmetric, and/or be attached to the side 402 of the waterway 404. The closing line 416 may be connected to the floating boom 410 to manage the slack as the alternate system 400 closes. As an alternative to the actuating lines, the system may use other methods of generating torque to actuate the pivoting beams/trusses 414. The direction of the river flow 406 is indicated by an arrow.

FIG. 4B depicts the alternate system 400 of FIG. 4A in a closed configuration 403. The closing line 416 is reeled in at the moored platform 420 which causes the pivoting beams/trusses 414 to pivot inward toward the side 402 of the waterway 404. The alternate system 400 may be deployed to the open configuration (401, FIG. 4A) by reeling in the opening line 418 at the moored platform 420 until the catch bin 412 has moved substantially into the flow of the waterway and the floating boom 410 is able to direct floating pollutants (not shown) into the catch bin. The moored platform 420 and moored buoy 408 may be attached and/or fixed to a portion of the side 402 of the waterway 404. In other embodiments, the moored platform 420 and moored buoy 408 may be attached proximate the side 402 of the waterway 404. The direction of the river flow 406 is indicated by an arrow.

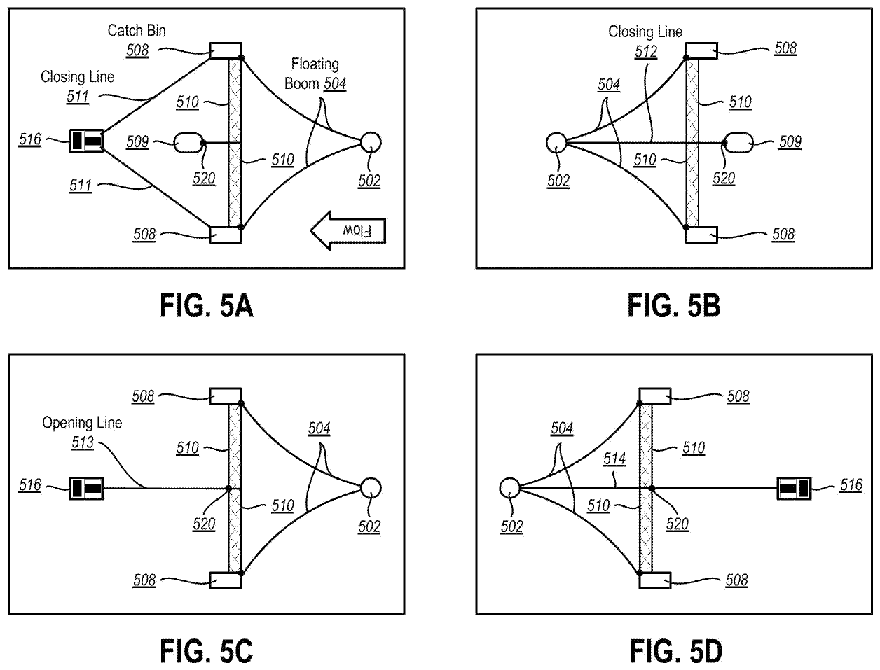

As depicted in FIGS. 5A, 5B, 5C and 5D, in some embodiments, the system may be used in a waterway or body of water where the relative flow direction between the water and the floating booms 504 is not expected to reverse while the system is in use. That is, in such embodiments, the flow of the water while the system was in use would generally either be negligibly small or be in the direction from the moored buoy 502 towards the other ends of the floating booms 504. This may be the case, for example, for a system that was placed in a river or waterway far from any periodic upstream tidal flow. This may also be the case for a system that is towed behind a vessel while in use. In such embodiments the actuation of the structure may be different than in an embodiment used where the flow was expected to reverse. If the relative flow direction did not reverse, the opening of the system may be accomplished without an opening line 513.

FIGS. 5A and 5B depict an alternate system where the opening is accomplished by, for example, force from the water flow on a drag feature 509 of the system that was submerged near the pivoting junction 520 of the two beam/truss 510 structures. The hydrokinetic forces on such a submerged drag feature 509 would create the force in the downstream direction necessary to overcome the other forces and open the system. FIG. 5B depicts a closing line 512 connecting the pivoting junction 520 to the vessel or moored buoy 502. Alternatively, FIG. 5A depicts closing lines 511 attached to a moored platform 516 that is further along the path of the water flow, relative to the rest of the system. The length of the closing lines 511 or 512 between these points could be shortened through the application of tension. Such tension, particularly in the case of a closing line 512 that connects close to the pivoting junction 520, could also have the effect of changing, reshaping or reorienting a submerged drag feature 509 connected to the pivoting junction 520 to reduce the drag force experienced by that feature 509 thereby reducing the tension necessary to close the system with the closing lines 511 or 512.

Alternatively, in embodiments intended for environments where the relative direction flow does not reverse, the system could be opened using an opening line 513 connected between the moored platform 516 and the pivoting junction 520 of the beams/trusses 510, as depicted in FIG. 5C. In such an embodiment, the closing of the system, could be accomplished by the drag forces from the river on the catch bins 508 and floating booms 504.

FIG. 5D depicts an alternate embodiment where the system is opened and closed using a loop of actuating line 514 connecting a line drive on either the moored platform 516 or the moored buoy and an idle pulley on the other of the two moored buoys 502 or moored platform 516. Such an embodiment would provide the advantage of having powered actuation for both opening and closing while requiring only a single powered drive.

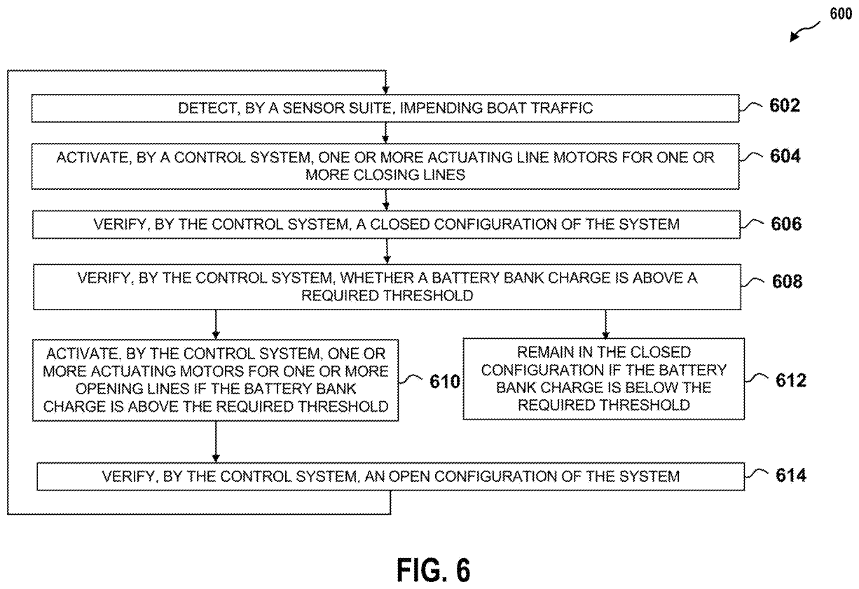

FIG. 6 depicts a high-level flowchart of a method 600 for deploying a system to reversibly span a surface of a waterway. The method 600 may include detecting, by a sensor suite, impending boat traffic (step 602). Detecting impending boat traffic may include information from a sensor suite; information from a power management system; and/or position information measured at actuating line spools. The method 600 may then include activating, by a control system, one or more actuating line motors for one or more closing lines (step 604). The method 600 may then include verifying, by the control system, a closed configuration of the system (step 606). The method 600 may then include verifying, by the control system, whether a battery bank charge is above a required threshold (step 608). If the battery bank charge falls below the required threshold to be able to deploy and then collapse again, the system may remain closed until sufficient stored power is available. The method 600 may then include activating, by the control system, one or more actuating line motors for one or more opening lines if the battery bank charge is above the required threshold (step 610). The method 600 may then include remaining in the closed configuration if the battery bank charge is below the required threshold (step 612). The method 600 may then include verifying, by the control system, an open configuration of the system (step 614). The method 600 may repeat once impending boat traffic is detected again (step 602).

In an alternative embodiment of the system, the control system would default to closing the system or maintaining the system closed unless both of the following conditions were met: the control system receives a signal from the sensor suite that it is appropriate to open, and the battery bank has sufficient charge to open and close the system. The control system would then only keep the system in the open configuration if it has received a recent signal from the sensor suite that there was no impending boat traffic. If a certain period of time passed without an affirmative signal from the sensor suite, the control system would close the system.

FIG. 7 depicts a high-level block diagram 700 of the moored platform 116 of the first system illustrated in FIG. 3A. The moored platform 116 may include one or more actuating line spools 702, one or more actuating line motors 704, one or more lights 706, a battery bank 708, a sensor suite 710, a control system 712, a power management system 714, one or more mooring anchors 716, one or more mooring lines 718, and one or more subsurface turbines 304, as disclosed herein. The control system 712 may be in communication with the one or more actuating line motors 704, the one or more lights 706, the battery bank 708, the sensor suite 710, the power management system 714, and/or the subsurface turbine 304. The control system 712 may have a processor with addressable memory. This functionality can be located on either the optional floating moored platform 156 of the second system of FIG. 1B or on the moving shuttle 160.

In an alternate embodiment, the sensor suite 710 may be located on the shore of the waterway or in a different location and communicates with the control system remotely through a wired or wireless connection.

In an alternate embodiment, the subsurface turbine 304 may be replaced by a photovoltaic solar panel and/or other power source.

In an alternate embodiment, all of the elements shown in FIG. 7, except the mooring anchors 716 and the mooring lines 718, may be included on or proximate to the pivoting beams/trusses.

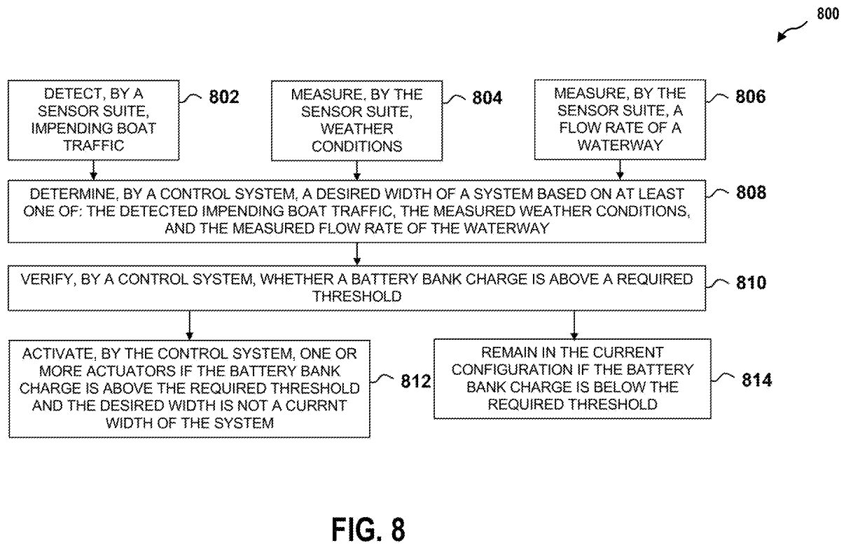

FIG. 8 depicts a high-level flowchart of a method 800 for determining a desired width of a system that spans at least a portion of a surface of a waterway, according to one embodiment. FIG. 8 may apply to an embodiment of the first system and the second system. The method 800 may include detecting, by a sensor suite, impending boat traffic (step 802). The method 800 may also include measuring, by the sensor suite, one or more weather conditions (step 804). The method 800 may also include measuring, by the sensor suite, a flow rate of a waterway (step 806). The method 800 may then include determining, by the control system, a desired width of the system based on at least one of: the detected impending boat traffic, the measured one or more weather conditions, and the measured flow rate of the waterway (step 808). The method 800 may then include verifying, by the control system, whether a battery bank charge is above a required threshold (step 810). The method 800 may then include activating, by the control system, one or more actuators if the battery bank is above the required threshold and the desired width is not a current width of the system (step 812). The method 800 may then include remaining in the current configuration and/or width if the battery bank charge is below the required threshold (step 814).

The method 800 may be used to collect floating pollutants that flow in the waterway. The method 800 may be used to move the system such that the system occupies either a wider width or narrower width of the waterway. When occupying a wider width of the waterway, the system has the ability to collect a greater quantity of pollutants but creates a greater impediment to boat traffic. When occupying a narrower width of the waterway, the system cannot collect as great a quantity of pollutants but the system is less of an impediment to boat traffic. In this method 800, the width of the system may be actively controlled, via the sensor suite and/or a control system having a processor having addressable memory, so as be able to collect pollutants without impeding boat traffic.

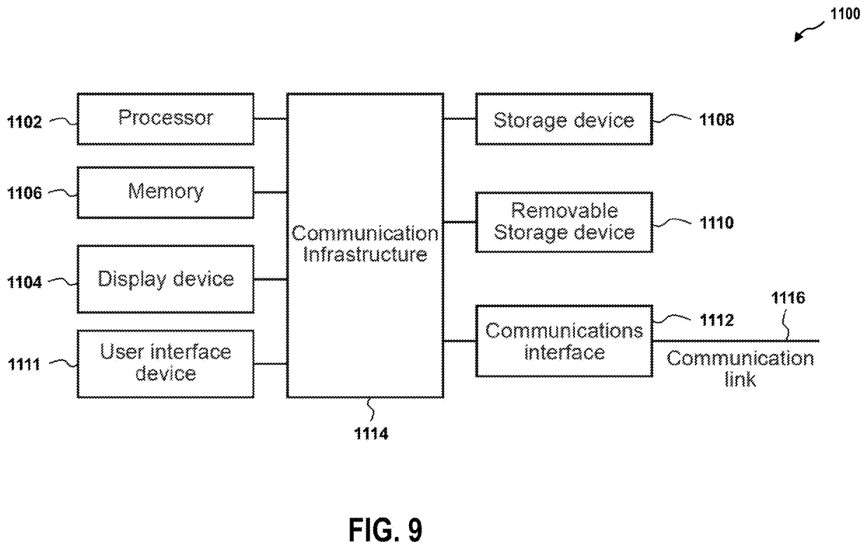

FIG. 9 is a high-level block diagram 1100 showing a computing system comprising a computer system useful for implementing an embodiment of the system and process, disclosed herein. Embodiments of the system may be implemented in different computing environments. The computer system includes one or more processors 1102, and can further include an electronic display device 1104 (e.g., for displaying graphics, text, and other data), a main memory 1106 (e.g., random access memory (RAM)), storage device 1108, a removable storage device 1110 (e.g., removable storage drive, a removable memory module, a magnetic tape drive, an optical disk drive, a computer readable medium having stored therein computer software and/or data), user interface device 1111 (e.g., keyboard, touch screen, keypad, pointing device), and a communication interface 1112 (e.g., modem, a network interface (such as an Ethernet card), a communications port, or a PCMCIA slot and card). The communication interface 1112 allows software and data to be transferred between the computer system and external devices. The system further includes a communications infrastructure 1114 (e.g., a communications bus, cross-over bar, or network) to which the aforementioned devices/modules are connected as shown.

Information transferred via communication infrastructure 1114 may be in the form of signals such as electronic, electromagnetic, optical, or other signals capable of being received by communication infrastructure 1114, via a communication link 1116 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1112. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

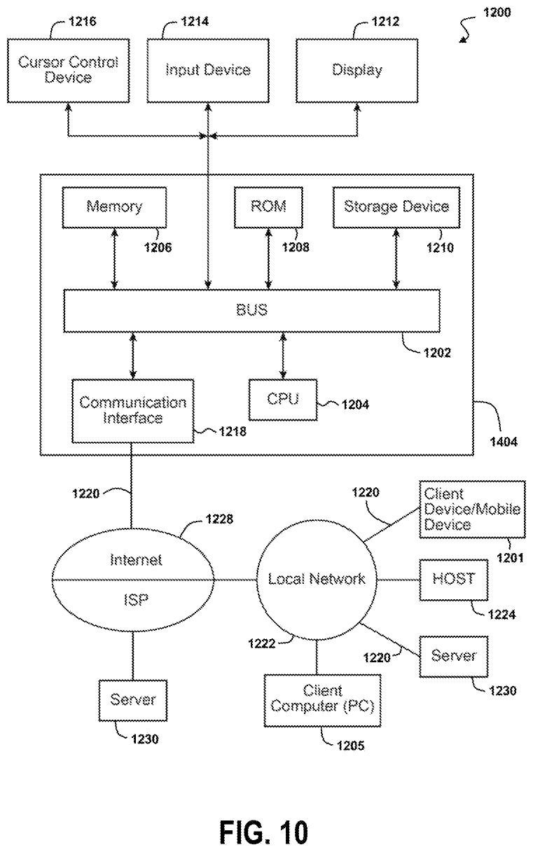

FIG. 10 shows a block diagram of an example system 1200 in which an embodiment may be implemented. The system 1200 includes one or more client devices 1201 such as consumer electronics devices, connected to one or more server computing systems 1230. A server 1230 includes a bus 1202 or other communication mechanism for communicating information, and a processor (CPU) 1204 coupled with the bus 1202 for processing information. The server 1230 also includes a main memory 1206, such as a random-access memory (RAM) or other dynamic storage device, coupled to the bus 1202 for storing information and instructions to be executed by the processor 1204. The main memory 1206 also may be used for storing temporary variables or other intermediate information during execution or instructions to be executed by the processor 1204. The server computer system 1230 further includes a read only memory (ROM) 1208 or other static storage device coupled to the bus 1202 for storing static information and instructions for the processor 1204. A storage device 1210, such as a magnetic disk or optical disk, is provided and coupled to the bus 1202 for storing information and instructions. The bus 1202 may contain, for example, thirty-two address lines for addressing video memory or main memory 1206. The bus 1202 can also include, for example, a 32-bit data bus for transferring data between and among the components, such as the processor 1204, the main memory 1206, video memory and the storage device 1210. Alternatively, multiplex data/address lines may be used instead of separate data and address lines.

The server 1230 may be coupled via the bus 1202 to a display 1212 for displaying information to a computer user. An input device 1214, including alphanumeric and other keys, is coupled to the bus 1202 for communicating information and command selections to the processor 1204. Another type or user input device comprises cursor control 1216, such as a mouse, a trackball, or cursor direction keys for communicating direction information and command selections to the processor 1204 and for controlling cursor movement on the display 1212.

According to one embodiment, the functions are performed by the processor 1204 executing one or more sequences of one or more instructions contained in the main memory 1206. Such instructions may be read into the main memory 1206 from another computer-readable medium, such as the storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor, which may be a multi-core processor to perform the features of the computer system. Accordingly, such computer programs represent controllers of the computer system.

Generally, the term “computer-readable medium” as used herein refers to any medium that participated in providing instructions to the processor 1204 for execution. Such a medium may take many forms, including but not limited to, non-volatile media, volatile media, and transmission media. Non-volatile media includes, for example, optical or magnetic disks, such as the storage device 1210. Volatile media includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the server 1230 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received from the main memory 1206 may optionally be stored on the storage device 1210 either before or after execution by the processor 1204.

The server 1230 also includes a communication interface 1218 coupled to the bus 1202. The communication interface 1218 provides a two-way data communication coupling to a network link 1220 that is connected to the worldwide packet data communication network now commonly referred to as the Internet 1228. The Internet 1228 uses electrical, electromagnetic, or optical signals that carry digital data streams. The signals through the various networks and the signals on the network link 1220 and through the communication interface 1218, which carry the digital data to and from the server 1230, are exemplary forms or carrier waves transporting the information.

In another embodiment of the server 1230, the communication interface 1218 is connected to a local network 1222 via a communication link 1220. For example, the communication interface 1218 may be an integrated services digital network (ISDN) card or a modem to provide a data communication connection to a corresponding type of telephone line, which can comprise part of the network link 1220. As another example, the communication interface 1218 may be a local area network (LAN) card to provide a data communication connection to a compatible LAN. Wireless links may also be implemented. In any such implementation, the communication interface 1218 sends and receives electrical, electromagnetic, or optical signals that carry digital data streams representing various types of information.

The network link 1220 typically provides data communication through one or more networks to other data devices. For example, the network link 1220 may provide a connection through the local network 1222 to a host computer 1224 or to data equipment operated by an Internet Service Provider (ISP). The ISP in turn provides data communication services through the Internet 1228. The local network 1222 and the Internet 1228 both use electrical, electromagnetic, or optical signals that carry digital data streams. The signals through the various networks and the signals on the network link 1220 and through the communication interface 1218, which carry the digital data to and from the server 1230, are exemplary forms or carrier waves transporting the information.

The server 1230 can send/receive messages and data, including e-mail, program code, through the network, the network link 1220 and the communication interface 1218. Further, the communication interface 1218 can comprise a USB/Tuner and the network link 1220 may be an antenna or cable for connecting the server 1230 to a cable provider, satellite provider or other terrestrial transmission system for receiving messages, data and program code from another source.

The example versions of the embodiments described herein may be implemented as logical operations in a distributed processing system such as the system 1200 including the servers 1230. The logical operations of the embodiments may be implemented as a sequence of steps executing in the server 1230, and as interconnected machine modules within the system 1200. The implementation is a matter of choice and can depend on performance of the system 1200 implementing the embodiments. As such, the logical operations constituting said example versions of the embodiments are referred to for e.g., as operations, steps, or modules.

Similar to a server 1230 described above, a client device 1201 can include a processor, memory, storage device, display, input device and communication interface (e.g., e-mail interface) for connecting the client device to the Internet 1228, the ISP, or local network 1222 (such as a local area network (LAN)), for communication with the servers 1230.

The system 1200 can further include computers (e.g., personal computers, computing nodes) 1205 operating in the same manner as client devices 1201, wherein a user can utilize one or more computers 1205 to manage data in the server 1230.

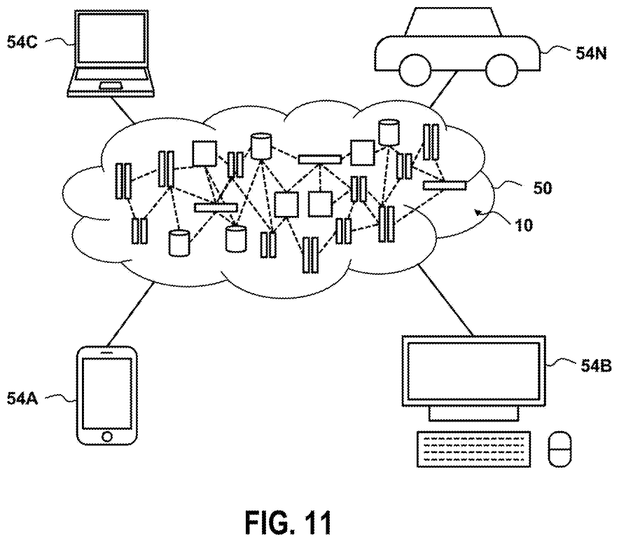

Referring now to FIG. 11, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

What is claimed is:

1. A system, comprising:
a moored buoy;
a pivoting beam located downstream of the moored buoy with respect to a direction of flow, wherein the pivoting beam is pivotable between an open configuration and a closed configuration, wherein the pivoting beam comprises floats;
a moored platform located downstream relative to a pivoting beam with respect to a direction of a waterway flow;
an upstream floating boom having an upstream first end and an upstream second end, the upstream floating boom attached to the moored buoy at the upstream first end, wherein the upstream floating boom is attached to a pivoting end of the pivoting beam at the upstream second end;
a downstream floating boom having a downstream first end and a downstream second end, the downstream floating boom attached to the moored platform at the downstream first end;
a catch bin located at the pivoting end of the pivoting beam and the downstream second end of the downstream floating boom, wherein, in the open configuration of the pivoting beam, the upstream floating boom is configured to guide floating pollutants into the catch bin, wherein the catch bin includes a gate located at the pivoting end of the pivoting beam, wherein the gate prevents loss of trash during a tidal flow; and
a floating shuttle located at a hinge of the pivoting beam, wherein the floating shuttle includes:
a battery bank;
control system;
power management system; and
actuating motors/spools.

2. The system of claim 1, wherein the floating shuttle comprises a motor that is capable of pulling both a downstream line and a upstream line to cause the pivoting beam to close and open.

3. The system of claim 2, wherein the downstream line is coupled from the floating shuttle to the moored platform and the upstream line is coupled from the floating shuttle to the moored buoy.

4. The system of claim 3, wherein the upstream line and the downstream line are a continuous line.

5. The system of claim 1, wherein the upstream floating boom includes a first floating boom and a second floating boom, the first floating boom and the second floating boom connected to the moored buoy at the first end of each of the first floating boom and the second floating boom, wherein the downstream floating boom includes a third floating boom and a fourth floating boom, the third floating boom and the fourth floating boom connected to the moored platform at the first end of each of the third floating boom and the fourth floating boom.

6. The system of claim 5, wherein the pivoting beam includes a first pivoting beam and a second pivoting beam, the first pivoting beam connected to the second pivoting beam at a center hinge, the first floating boom connected to the first pivoting beam and the second floating boom connected to the second pivoting beam.

7. The system of claim 1, further comprising a closing line configured to move the pivoting beam into the closed configuration, wherein the closing line is connected to the moored platform and the pivoting beam, and wherein, when the closing line is retracted, the pivoting beam moves from the open configuration to the closed configuration.

8. The system of claim 1, further comprising an opening line configured to move the pivoting beam into the open configuration, wherein the opening line is connected to a moored platform and the pivoting beam, and wherein, when the opening line is retracted, the pivoting beam moves from the closed configuration to the open configuration.

9. The system of claim 1, further comprising a power generation turbine located on the pivoting beam.

10. The system of claim 1, wherein the moored buoy is configured to be connected to a vessel.

11. The system of claim 1, wherein the moored platform is a mechanized trash collection conveyor or a simple moored buoy.

12. The system of claim 1, wherein one or more downstream floating booms are attached to the moored platform to create a debris collection area.

13. The system of claim 1, wherein the pivoting beam comprises a structure of floats to provide sufficient strength to withstand static and dynamic forces.

14. A method, comprising:
detecting, by a sensor suite, impending boat traffic;
activating an upstream line and a downstream line that are each coupled to a shuttle to move a pivoting beam from an open configuration to a closed configuration, an upstream floating boom connected to a moored buoy at a first end of the upstream floating boom and the pivoting beam at a second end of the upstream floating boom, a downstream floating boom connected to a moored platform at a first end of the downstream floating boom and the pivoting beam at a second end of the downstream floating boom, a catch bin connected to the pivoting beam such that, in the open configuration, the upstream floating boom directs floating pollutants toward a gate of the catch bin, wherein activation is executed via a single pully or winch by a motor;
verifying that the pivoting beam is in the closed configuration;
detecting a charge of a battery bank, wherein if the charge of the battery bank is below a threshold, then the pivoting beam remains in the closed configuration;
if the charge of the battery bank is above the threshold, activating the motor for the upstream line and the downstream line; and
verifying that the pivoting beam is in the open configuration.

15. The method of claim 14, wherein the sensor suite, the battery bank, and the motor are located on the shuttle which are located at a hinge of the pivoting beam.

16. The method of claim 14, wherein the sensor suite includes one or more of a Marine RADAR system, mm-Wave radar, digital compass, visual camera, near-infrared camera, LIDAR, proximity sensors, optical tripwires, GPS location system, VHF radio, or an Automatic Identification System (AIS) transceiver.

17. The method of claim 14, further comprising charging the battery bank with a power generator.

18. The method of claim 17, wherein the power generator includes a turbine located on the pivoting beam.

19. The method of claim 14, wherein activating the motor includes activating the motor if the sensor suite detects no impending boat traffic.

20. A non-transitory computer readable medium containing programmable instructions for causing a computer to perform a method of:
detecting, by a sensor suite, an impending boat traffic in a waterway;
measuring, by the sensor suite, one or more weather conditions wherein the sensor suite is located in a floating platform shuttle;
measuring, by the sensor suite, a flow rate of a waterway;
determining a desired width of an open configuration of a pivoting beam based on at least one of: the impending boat traffic, the one or more weather conditions, or the flow rate of the waterway;
detecting a charge of a battery bank, wherein if the charge of the battery bank is below a threshold, then the pivoting beam remains in a closed configuration; and
activating an opening actuator for the pivoting beam if the battery bank is above the threshold and the desired width is greater than a current width of the pivoting beam;
wherein the floating platform shuttle activates opening and closing of the pivoting beam by pulling an upstream line and a downstream line, wherein the upstream line is coupled between a moored buoy and the pivoting beam, and the downstream line is coupled between a moored platform and the pivoting beam.
